(19) United States
(12) Patent Application Publication
(10) Pub. No.: US 2015/0034053 A1
(43) Pub. Date: Feb. 5, 2015

(54) FUEL INJECTOR AND METHOD FOR FORMING SPRAY-DISCHARGE ORIFICES

(71) Applicants: Dieter Maier, Rettenberg (DE); Gerhard Stransky, Immenstadt (DE); Andreas Schrade, AM Tilburg (NL)

(72) Inventors: Dieter Maier, Rettenberg (DE); Gerhard Stransky, Immenstadt (DE); Andreas Schrade, AM Tilburg (NL)

(21) Appl. No.: 14/365,480

(22) PCT Filed: Oct. 30, 2012
(86) PCT No.: PCT/EP2012/071446

§ 371 Date: Jun. 13, 2014

(30) Foreign Application Priority Data
Dec. 20, 2011 (DE) 10 2011 089 240.0

(51) Int. Cl. F02M 51/06; B22F 5/10; B22F 3/12

(52) U.S. Cl. CPC F02M 51/06; B22F 3/12; B22F 5/10
USPC 123/490; 419/5

(57) ABSTRACT

A fuel injector for fuel injection systems of internal combustion engines has an energizable actuator for actuating a valve-closure member, which, together with a valve seat face configured on a valve seat body, forms a sealing seat. Downstream of the valve seat face, a plurality of spray-discharge orifices are formed, which include one upstream, first spray-discharge orifice section and one downstream, second spray-discharge orifice section having different orifice widths. The orifice sections of the individual spray-discharge orifices extend coaxially to the particular longitudinal bore axis. The spray-discharge orifices are formed in a valve component manufactured as a metal injection molding part.

### BACKGROUND OF THE INVENTION

1. Field of the Invention

The present invention is directed to a fuel injector and to a method for forming spray-discharge orifices.

2. Description of the Related Art

The published British Patent Application GB 1,088,666 A already describes a fuel injector that has a stepped spray-discharge orifice. Starting from a chamber-shaped valve interior in a first orifice section, the spray-discharge orifice is configured with a very small flow rate-determining orifice width, while a second orifice section contiguous thereto is considerably enlarged. The second orifice section may be designed to be either cylindrically or conically broadened. The spray-discharge orifices are introduced using conventional techniques, such as drilling, milling, punching or erosion.

The published German Patent DE 42 30 376 C1 also discusses a fuel injector whose valve needle is manufactured using what is generally referred to as the metal injection molding method (MIM method). In the case of the valve needle, a tubular actuating part, composed of an armature section and a valve sleeve section, is produced by injection molding and subsequent sintering. The actuating part is subsequently joined by a welded connection to a valve closing element section, so that the valve needle is still composed of merely two individual components. A through-extending, internal longitudinal opening is provided in the armature section and the valve sleeve section, in which fuel can flow toward the valve closing element section and then exit close to the valve closing element section out of the valve sleeve section through transverse openings. Thus, when the MIM method is used to manufacture the valve needle, slide molds are needed in order to form the transverse openings.

The published German Patent DE 40 33 952 C1 already discusses a binary binder system of the solid polymer solutions type used in metal injection molding technology. It is characterized by the use of physiologically harmless low-molecular binder components and by the omission of wetting agents. Dense molded parts made of metal powders are readily produced in this manner by injection molding, and the binder removed therefrom, without any contraction or warpage occurring.

The published German Patent Application DE 10 2005 036 951 A1 already describes a fuel injector that has the feature whereby the valve seat body is manufactured using metal injection molding methods. A plurality of spray-discharge orifices are formed in the valve seat body downstream of the valve seat face. The spray-discharge orifices include at least one upstream, first spray-discharge orifice section and one downstream, second spray-discharge orifice section having a different orifice width. A wall region of the second spray-discharge orifice region (“first stages”) of all spray-discharge orifices extends on a reference circle either in parallel or at a right angle to the longitudinal axis of the valve seat body having the spray-discharge orifices. The first stages of the spray-discharge orifices must be demolded separately.

### BRIEF SUMMARY OF THE INVENTION

The fuel injector according to the present invention has the advantage of being especially simple and cost-effective to manufacture. Ideally, the valve component having the spray-discharge orifices, in particular, the valve seat body is manufactured using metal injection molding methods (MIM). It is a distinguishing feature of the present invention that large numbers of spray-discharge orifices having complex contours may be formed with high accuracy using a tool in a molded part manufactured using MIM methods, making it possible to provide highly precise spray-discharge orifices that extend coaxially to the particular longitudinal bore axes. The inventive configuration and design variant of the spray-discharge orifices in the valve component make it possible for a multiplicity of reproducible spray-discharge orifices to be formed simultaneously.

The method according to the present invention for forming spray-discharge orifices has the advantage of making it possible for the contours of the spray-discharge orifice sections to be integrated in an injection mold while allowing for considerable variance due to the bore-specific formability of the spray-discharge orifices along each individual, differently oriented longitudinal bore axis. Significant cost advantages are attained in comparison to known approaches since the spray-discharge orifices, along with the spray-discharge orifice sections thereof, may be produced using a tool. Known separate machining operations for manufacturing the spray-discharge orifice sections, such as punching, drilling, erosion, or laser drilling, may be eliminated. The present invention makes possible a highly reproducible manufacturing of spray-discharge orifices, along with the spray-discharge orifice sections thereof, achieving the highest quality features, while maintaining all dimensional tolerances, shape tolerances, and positional tolerances.

### BRIEF DESCRIPTION OF THE DRAWINGS

FIG. 1 shows a schematic section of an exemplary embodiment of a fuel injector having spray-discharge orifices formed in accordance with the present invention in a valve seat body.

FIG. 2 shows detail II in the area of a spray-discharge orifice in FIG. 1 in an enlarged view, the spray-discharge orifice being configured in a first variant.

FIG. 3 shows the enlarged view of the spray-discharge orifice in accordance with FIG. 2, including two additional alternative variants.

FIG. 4 shows the enlarged view of a spray-discharge orifice in a fourth variant.

### DETAILED DESCRIPTION OF THE INVENTION

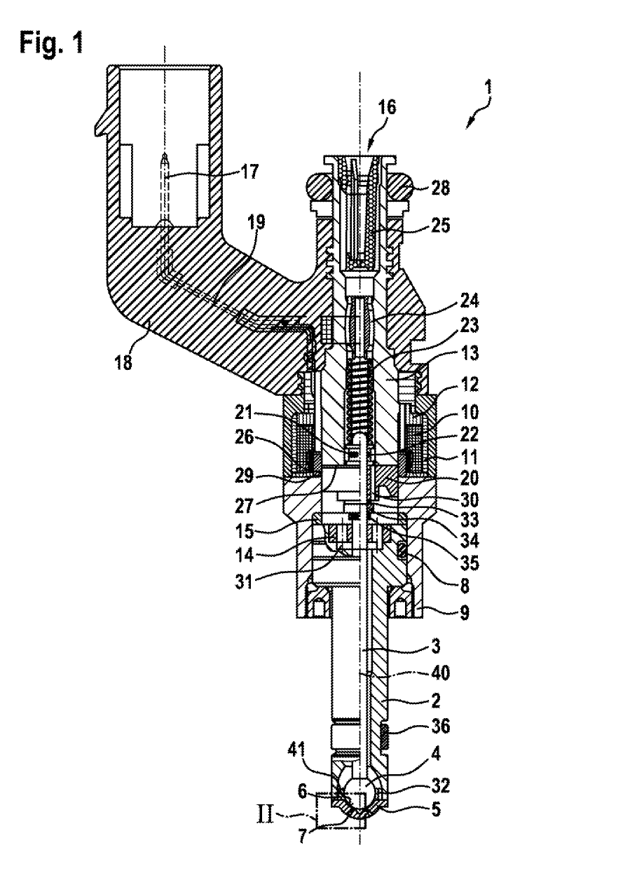

An exemplary embodiment of a fuel injector 1 illustrated in FIG. 1 is designed in the form of a fuel injector 1 for fuel injection systems of mixture-compressing, spark-ignition internal combustion engines. Fuel injector 1 is particularly suited for the direct injection of fuel into a combustion chamber (not shown) of an internal combustion engine.

Fuel injector 1 is composed of an injection nozzle body 2 in which a valve needle 3 is configured. Valve needle 3 is operatively connected to a valve closure member 4 that cooperates with a valve seat face 6 configured on a valve seat body 5, to form a sealing seat. In the exemplary embodiment, fuel injector 1 is an inwardly opening fuel injector 1 that has at least two spray-discharge orifices 7. Ideally, however, fuel injector 1 is designed as a multiorifice injector and, therefore, has between four and thirty spray-discharge orifices 7. A seal 8 seals injection nozzle body 2 against a valve housing 9. As a drive, an electromagnetic circuit is used, for example, that includes a solenoid coil 10 as an actuator, which is encapsulated in a coil housing 11 and wound on a coil brace 12 that rests against an inner pole 13 of solenoid coil 10. Inner pole 13 and valve housing 9 are separated from one another by a constriction 26 and are interconnected by a non-ferromagnetic connecting part 29. Solenoid coil 10 is energized via a line 19 by an electric current that may be fed via an electrical plug contact 17.

Plug contact 17 is enclosed by a plastic coating 18 that is extrudable onto inner pole 13.

Valve needle 3 is guided in a valve needle guide 14 which is disk-shaped. A paired adjusting disk 15 is used to adjust the valve lift. An armature 20 is located on the other side of adjusting disk 15. It is connected nonpositively via a first flange 21 to valve needle 3 that is connected by a weld seam 22 to first flange 21. Braced against first flange 21 is a restoring spring 23 which, in the present design of fuel injector 1, is pretensioned by an adjusting sleeve 24.

Fuel channels 30, 31 and 32 extend in valve needle guide 14, in armature 20 and on a guide element 41. The fuel is supplied via a central fuel feed 16 and filtered by a filter element 25. Fuel injector 1 is sealed by a seal 28 against a fuel distributor line (not shown further) and by another seal 36 against a cylinder head (not shown further).

An annular shaped damping element 33, made of an elastomeric material, is configured on the downstream side of armature 20. It rests on a second flange 34 that is connected nonpositively via a weld seam 35 to valve needle 3.

In the quiescent state of fuel injector 1, restoring spring 23 acts on armature 20 against the direction of lift thereof in such a way that valve closure member 4 is held in sealing contact on valve seat face 6. Upon excitation, solenoid coil 10 builds up a magnetic field that moves armature 20 in the lift direction, counter to the spring force of restoring spring 23, the lift being predefined by a working gap 27 located between inner pole 12 and armature 20 in the position of rest. Armature 20 likewise entrains first flange 21, which is welded to valve needle 3, in the lift direction. Valve closure member 4, which is connected to valve needle 3, lifts off from valve seat face 6, and the fuel is spray-discharged through spray-discharge orifices 7.

If the coil current is switched off, armature 20 falls off from inner pole 13 in response to the pressure of restoring spring 23 once the magnetic field has sufficiently decayed, whereby first flange 21, which is connected to valve needle 3, moves in a direction counter to the lift. Valve needle 3 is thereby moved in the same direction, whereby valve closure member 4 sets down on valve seat face 6, and fuel injector 1 is closed.

In accordance with the present invention, spray-discharge orifices 7 are specifically configured in valve-seat body 5. Valve seat body 5 is advantageously manufactured using what is generally referred to as the MIM method. The already known method, which is also referred to as metal injection molding (MIM), includes the manufacture of molded parts from a metal powder and a binding agent, such as a plastic binding agent, which are mixed together and homogenized, for example, using conventional injection molding machines for plastics, and includes the subsequent removal of the binding agent and sintering of the remaining metal powder skeleton. The composition of the metal powder may be readily adapted to optimal magnetic and thermal properties.

Fuel injectors 1 used in the direct injection of fuel into the combustion chamber of an internal combustion engine are subject to a significant risk of coating formation on the downstream components, such as spray-orifice disks and valve seat bodies. Spray-discharge orifices 7 are particularly susceptible to coking of the free cross section, so that there may be a disadvantageous reduction in the desired spray-discharge quantities. Therefore, it is desirable to selectively adjust the thermal balance in the region of the downstream end of fuel injector 1 around valve seat body 5. Moreover, a constant volumetric flow rate for the spray discharging via spray-discharge orifices 7 is to be optimally ensured over the entire service life of fuel injector 1. It has been found that, particularly in the case of stepped spray-discharge orifices 7 having an enlarged orifice width in the downstream direction, there is a significant reduction in the tendency for coating formation, coking, and thus for clogging of the free cross section of spray-discharge openings 7.

It is a distinguishing feature of the present invention that large numbers of stepped, respectively sectionally subdivided spray-discharge orifices 7 may be formed in a molded part manufactured using MIM methods, in this case in valve seat body 5, very simply and cost-effectively and with high accuracy using a tool. In the case of known spray-discharge orifices of fuel injectors, which are configured as multiorifice valves, every spray-discharge orifice; respectively, in the case of stepped spray-discharge orifices, every downstream spray-discharge orifice section has its own solid angle. This manner of configuring and designing spray-discharge orifices 7 in the valve seat body 5 renders difficult an optimized and cost-effective and, thus, simultaneous formation of a multiplicity of spray-discharge orifices 7.

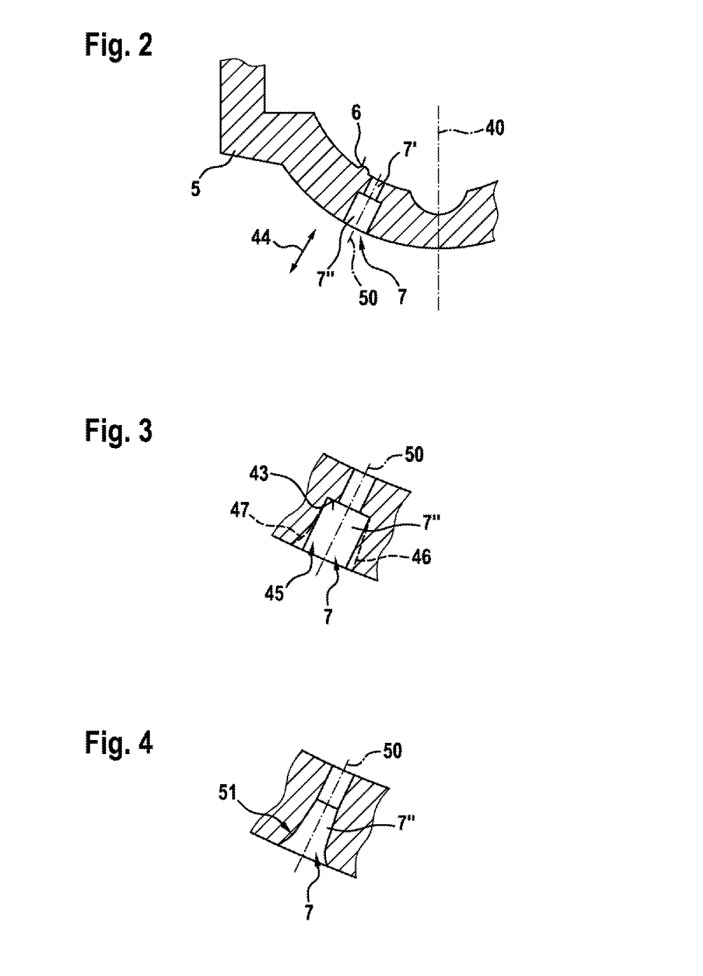

The present invention makes it possible for stepped, sectionally subdivided spray-discharge orifices 7 to be formed very advantageously to a high degree of precision. FIG. 2 shows detail II in the area of a spray-discharge orifice 7 in FIG. 1 in an enlarged representation in a first variant, it being clearly discernible that spray-discharge orifice 7 includes two spray-discharge orifice sections 7′, 7″. Upstream, first spray-discharge orifice 7′ has a distinctly smaller orifice width than the downstream, following second spray-discharge orifice section 7″. The orientation of the two spray-discharge orifice sections 7′, 7″ of one and the same spray-discharge orifice 7 is identical, so that a spray-discharge orifice 7 extending completely coaxially to longitudinal bore axis 50 is, therefore, present.

FIG. 3 shows the enlarged view of spray-discharge orifice 7 in accordance with FIG. 2, including two additional alternative variants. All three specific embodiments of spray-discharge orifice 7 are designed to provide a step 43 in the form of an offset between the two spray-discharge orifice sections 7′, 7″ of different orifice widths. In the first variant, second, downstream spray-discharge orifice section 7″ starts from step 43 and extends with a cylindrical wall section 45; in the second variant illustrated by a dotted line on the right side, respectively in the variant having an obliquely inclined, conical wall section 46; and in the third variant illustrated by a dotted line on the left side, it extends with a parabolically-, respectively trompet-shaped wall section 47. All of the exemplary embodiments have in common that spray-discharge orifice 7 extends over the entire length thereof concentrically to longitudinal bore axis 50.

Arrows 44 in FIG. 2 indicate that, in such an embodiment of spray-discharge orifice sections 7′, 7″, all spray-discharge orifices 7 are axially removable using a tool at the same time along longitudinal bore axis 50 in an ideal fashion in the MIM process. To this end, the appropriate injection mold is designed in a way that allows ready-out-of-the-mold manufacturing of spray-discharge orifices 7. This means that the particular mold pins (not shown) are either sealed flat against the inner core or dip into the inner mold core. Alternatively, it may also be provided that the mold pins not seal against the inner core, but that rather a small intermediate space be left between the mold pin tip and the inner core. This intermediate space is filled with material that must still be removed in the injection state or in the finished MIM state.

FIG. 4 shows the enlarged view of a spray-discharge orifice 7 in a fourth variant. In this exemplary embodiment, there is no step 43 between spray-discharge orifice section 7′, 7″. Rather, first upstream spray-discharge orifice section 7′ extends cylindrically, while, disposed contiguously thereto and beginning from a middle bore plane, is second, downstream spray-discharge orifice section 7″, whose wall section 51, analogously to the exemplary embodiment shown in FIG. 3, is formed in a parabolic or trumpet shape. Alternatively, this wall section 51 may also extend out conically.

The axial formability of stepped, respectively sectionally subdivided spray-discharge orifices 7 makes it possible for the contours of spray-discharge orifice sections 7″ to be integrated in an injection mold while allowing for considerable variance. Significant cost advantages are attained in comparison to known approaches since spray-discharge orifices 7, along with the spray-discharge orifice sections 7′, 7″, thereof may be manufactured using a tool. Known separate machining operations for manufacturing spray-discharge orifice sections 7′, 7″, such as punching, drilling, erosion, or laser drilling, for example, may be eliminated. The present invention makes possible a highly reproducible manufacturing of spray-discharge orifices 7, along with the spray-discharge orifice sections 7′, 7″ thereof, achieving the highest quality features, while maintaining all dimensional tolerances, shape tolerances, and positional tolerances.

The present invention is not limited to the described exemplary embodiments and may be used for differently configured spray-discharge orifices 7, for example.

1-10. (canceled)

11. A fuel injector for a fuel injection system of an internal combustion engine, comprising:
a valve seat face configured on a valve seat body;
a valve-closure member, wherein the valve-closure member and the valve seat face together form a sealing seat;
an energizable actuator for actuating the valve-closure member; and
spray-discharge orifices formed downstream of the valve seat face, wherein the spray-discharge orifices each include at least one upstream, first spray-discharge orifice section and one downstream, second spray-discharge orifice section having different orifice widths, and wherein the first and second spray-discharge orifice sections of each individual spray-discharge orifice extend coaxially to a longitudinal bore axis of the respective spray-discharge orifice, and wherein the spray-discharge orifices are formed in a valve component manufactured as a metal injection molding part.

12. The fuel injector as recited in claim 11, wherein the valve component having the spray-discharge orifices is the valve seat body.

13. The fuel injector as recited in claim 12, wherein a step structure in the form of an offset is provided between the first and second spray-discharge orifice sections of different orifice widths.

14. The fuel injector as recited in claim 13, wherein the second, downstream spray-discharge orifice section of the spray-discharge orifice starts from the step structure and extends with a cylindrical wall section.

15. The fuel injector as recited in claim 13, wherein, starting from the step structure, the second, downstream spray-discharge orifice section of the spray-discharge orifice extends with an obliquely inclined, conical wall section.

16. The fuel injector as recited in claim 13, wherein, starting from the step structure, the second, downstream spray-discharge orifice section of the spray-discharge orifice extends with a parabolically-shaped wall section.

17. The fuel injector as recited in claim 12, wherein:
the first, upstream spray-discharge orifice section extends cylindrically;
the second, downstream spray-discharge orifice section begins from a middle bore plane and is disposed contiguously to the first, upstream spray-discharge orifice section, and the second, downstream spray-discharge orifice section has a wall section which is one of parabolically-shaped or conically formed.

18. The fuel injector as recited in claim 13, wherein the spray-discharge orifices are axially demolded at the same time along the longitudinal bore axes.

19. The fuel injector as recited in claim 13, wherein between two and thirty spray-discharge orifices are provided in the metal injection molding valve component.

20. A method for forming spray-discharge orifices on a valve component of a fuel injector, the valve component being manufactured using a metal injection molding method, comprising:
mixing and homogenizing a metal powder and a binding agent;
performing a subsequent injection molding;
removing the binding agent; and
sintering a resulting metal powder skeleton; and
forming the spray-discharge orifices in the metal powder skeleton in such a way that each spray-discharge orifice includes at least one upstream, first spray-discharge orifice section and one downstream, second spray-discharge orifice section having different orifice widths, wherein the first and second spray-discharge orifice sections of each individual spray-discharge orifice extend coaxially to a longitudinal bore axis of the respective spray-discharge orifice, and wherein the spray-discharge orifices are demolded at the same time.
